(19) United States
(12) Patent Application Publication
(10) Pub. No.: US 2003/0011108 A1
(43) Pub. Date: Jan. 16, 2003

(54) Assembly display modules

(76) Inventor: Dennis L. Matthies, Princeton, NJ (US)

Correspondence Address: Timothy N. Trop, TROP, PRUNER & HU, P.C., STE 100, 8554 KATY FWY, HOUSTON, TX, 77024-1805, US

(21) Appl. No.: 09/904,269

(22) Filed: Jul. 12, 2001

(51) Int. Cl. B29C 43/02; C03B 23/02

(52) U.S. Cl. 264/510; 264/511; 264/544; 264/571; 65/106

(57) ABSTRACT

A sheet utilized in making electronic displays may be prone to warping. This warping may result in the failure to make good surface-to-surface contact or even electrical connections between layers. By processing the sheet prone to warpage in a flattened configuration, the occurrence of stress-induced cracking when the sheet is applied to a rigid planar structure may be reduced. Moreover, a distorted sheet may be processed economically while still resulting in a final product which is regular, flat and planar.

### BACKGROUND

This invention relates generally to the manufacture of displays for electronic devices.

In a number of cases, displays for electronic devices may be made from a plurality of layers. In some cases, these layers are of microelectronic dimensions. One layer may be warped or non-flat relative to the other layer. It may be desired to electrically interconnect these layers with at least one of the layers being re-shaped or flattened so that contact distance is the same.

For example, displays may include a glass layer which generally is free of warpage and is effectively perfectly flat. However, ceramic layers, for example for making circuit boards, may be warped or non-flat.

Given the distortion of one of two layers to be joined, a number of possibilities arise. One adverse consequence of the distortion is that some of the contacts between the two layers are not effective across the abutting area between the two surfaces. Another possibility is that one of the layers, such as the glass layer, may warp to conform to the other layer such as a ceramic layer. Another possibility is that the ceramic layer may warp to conform to the glass layer. Still another possibility is that each of the layers warp to some degree. As still another possibility, residual stresses may be formed that may cause contacts to fail between layers. The residual stress may arise because of the stress on materials formed on layers, due to the distortion of layers or even due to the fact that the layers eventually return to an undistorted shape after being processed in a distorted shape.

Referring to FIG. 8, a circuit board layer 12a may be secured to a display panel 12b by a plurality of contacts indicated at 16. Because of the warpage of the circuit layer 12a, some or all of the contacts 16 either may not make good electrical connection or contacts that originally made connection may break free, resulting in open circuits.

To the extent that any layer warps or distorts because of the distortion of the other layer, the possibility exists of destroying structures which are formed on a given layer. Namely, if a layer is restored to an unwarped configuration (which may be necessary in use in some cases), the interconnections and other structures that are formed on one or more layers may be disturbed.

Thus, there is the need for a way to deal with the possibility of warped layers or components in assembling display modules.

### BRIEF DESCRIPTION OF THE DRAWINGS

FIG. 1 is a cross-sectional view of a chuck that is useful in accordance with one embodiment of the present invention;

FIG. 2 is a cross-sectional view of a pair of chucks in opposition in accordance with one embodiment of the present invention;

FIG. 3 is a cross-sectional view of a chuck holding a pair of display layers in accordance with one embodiment of the present invention;

FIG. 4 is a cross-sectional view of the attachment of the display layers to an integrating plate in accordance with one embodiment of the present invention;

FIG. 5 is a side elevational view of one embodiment of the present invention;

FIG. 6 is a top plan view of the embodiment shown in FIG. 5;

FIG. 7 is a partial, enlarged, cross-sectional view of one embodiment of the present invention; and

FIG. 8 is a cross-sectional view of an embodiment in accordance with the prior art.

### DETAILED DESCRIPTION

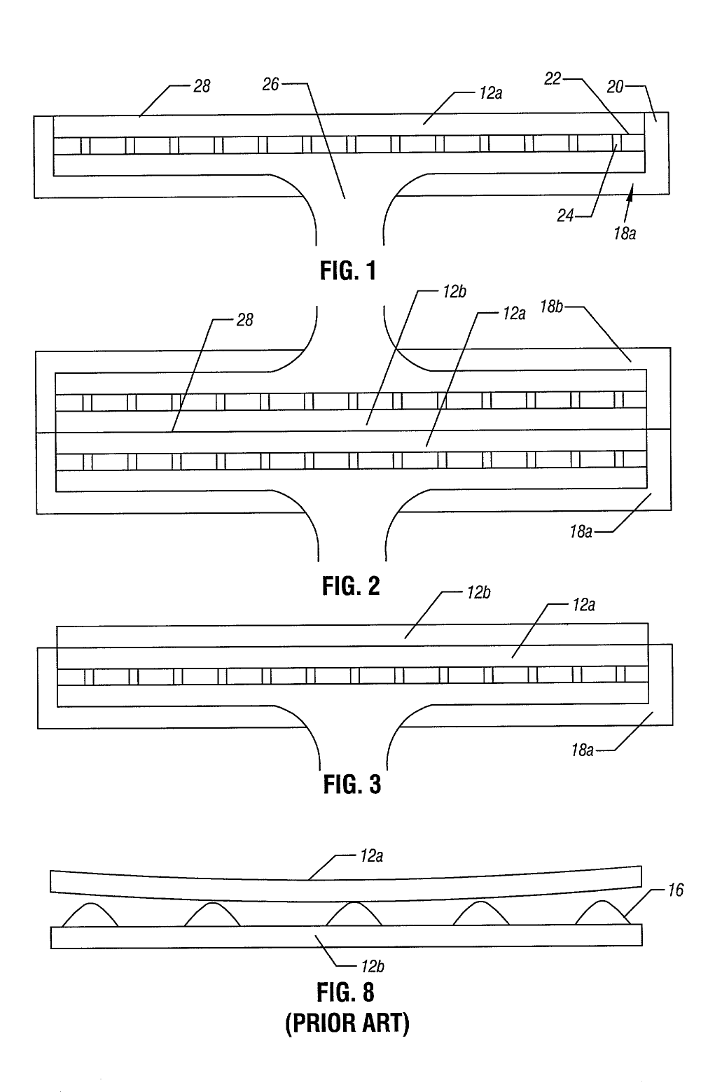

Referring to FIG. 1, a chuck 18a may be utilized to secure a circuit board layer 12a in a flat configuration in one embodiment. In one embodiment, the circuit board layer 12a may be made of a ceramic material that may warp. Applying a vacuum through the chamber 26 within the chuck 18a, the circuit board layer 12a may be secured for processing in a flat or flattened configuration with the surface 28 facing upwardly for processing.

The vacuum applied through the chamber 26 may be distributed across the surface of the circuit board layer 12a by the diffuser 22 including a plurality of openings 24 in one example. Thereafter, the circuit board layer 12a may be subjected to any necessary processing.

Advantageously, since the circuit board layer 12a may initially have been warped, but is now held in a flattened configuration, the circuit board layer 12a is processed in a planar configuration. Thus, if ultimately the circuit board layer 12a is maintained in a flat planar configuration, it is not necessary to stress the processed features that have been applied to the surface 28 of the circuit board layer 12a.

Referring to FIG. 2, the chuck 18b may be utilized to similarly secure a display panel 12b in accordance with one embodiment of the present invention. In this example, the circuit board layer 12a may be attached to the back side or nondisplay side of the panel 12b. Commonly, the display panel 12b may include a glass panel with light emitting elements secured or deposited to the panel 12b. For example, in one embodiment, organic light emitting devices (OLEDs) may be formed by depositing organic light emitting materials and associated column and row electrodes on a glass sheet.

The display panel 12b may be processed through a series of steps in which the display panel 12b is held in a flat configuration by the chuck 18b. When the processing of both circuit board layer 12a and display panel 12b has been completed, the two chucks 18 are arranged in juxtaposition as shown in FIG. 2 and the display panel 12b and the circuit board layer 12a have their processed sides combined as indicated at 28.

The connections between the circuit board layer 12a and the display panel 12b, in one embodiment, may be electrical connections using solder as one example. For example, in accordance with conventional flip chip or surface mount packaging techniques, solder bumps or balls may be utilized to provide electrical connections between the display panel 12b and the circuit board layer 12a. In one example, chucks 18a and 18b may be heated chucks to cause the solder to soften and fuse the display panel 12b to the circuit board layer 12a, thereby forming electrical connections as well as a physical bond between two parts.

Next, the chuck 18b may be removed to expose the display panel 12b, now secured to the circuit board layer 12a as indicated in FIG. 3. However, in this configuration, both the circuit board layer 12a and the display panel 12b may be held in a flat (or flattened) configuration in one embodiment.

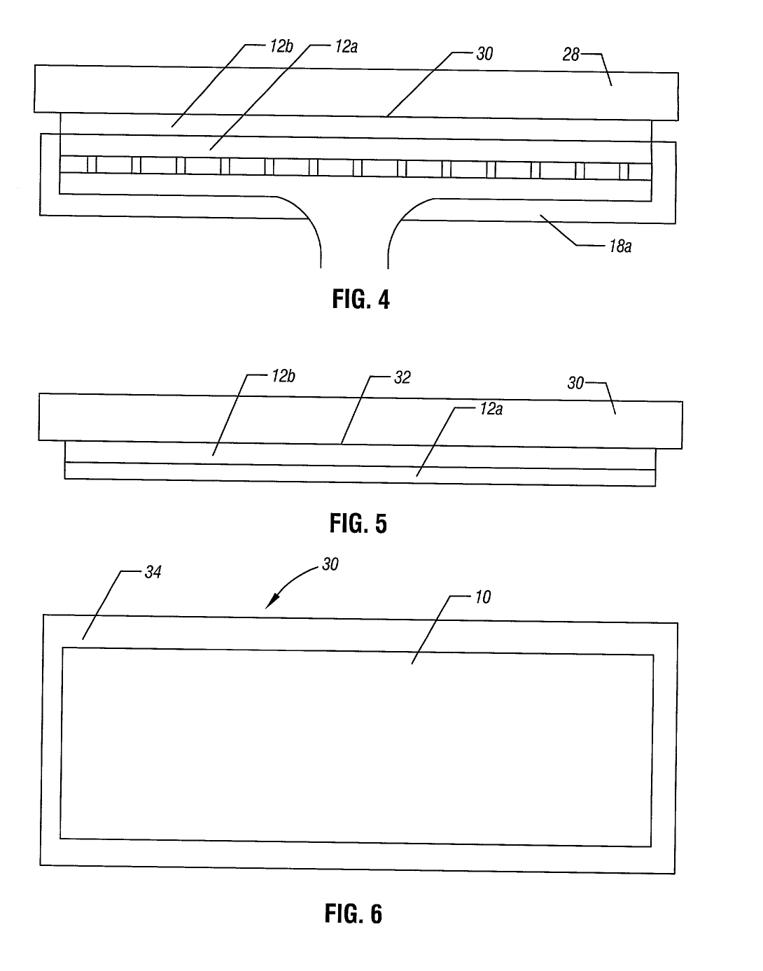

In one embodiment, the composite of the circuit board layer 12a and the display panel 12b may be secured to an optical integrating plate 30 as shown in FIG. 4. The optical integrating plate 30 may include a structure that holds the composite of the circuit board layer 12a and the display panel 12b in a flat, secured position, as indicated in FIG. 5.

The integrating plate 30 may include a transparent sheet that allows the display panel 12b to be viewed through the optical integrating plate 30. In some embodiments, the optical integrating plate 30 may provide a diffusing effect. In other cases, the integrating plate 30 may provide the effect of integrating a plurality of discrete display portions or tiles into an overall large area display.

In one embodiment, the integrating plate 30 is adhesively secured to the display panel 12b. The panel 12b may be secured by surface mount techniques to the circuit board layer 12a.

At this point, the securement between the chuck 18a and the circuit board layer 12a may be released since the optical integrating plate 30 holds the assembly in a flat configuration. Because the layer 12a and the panel 12b were processed in a flat configuration, the interconnections and elements that are attached during processing to the layer 12a and panel 12b are not unnecessarily stressed because these elements are always held in a flat configuration during processing and through use.

Referring to FIG. 6, the optical integrating plate 30 may include a transparent section 10. The display panel 12b may be secured to the opposite surface of the one shown in FIG. 6. The transparent plate 10 may be encircled by a frame 34 which provides rigidity to the optical integrating plate 30 and may provide a more pleasing appearance.

Because of potential warping, for example, of the circuit board layer 12a, if the display panel 12b and layer 12a are processed in a conventional fashion, the stresses between the circuit board layer 12a and panel 12b may cause the contacts 16, which may be solder balls, to break and release when the circuit board layer 12a for example attempts to return to its original shape. Alternatively, because of the warping of the circuit board layer 12a, good electrical contact may not be made between the layer 12a and panel 12b. Thus, to prevent stress-induced cracking and to make sure that good surface-to-surface contact for electrical connections are established, processing the two sheets in a flat configuration and then securing them to an integrating plate 30 may be advantageous in some embodiments.

Although an embodiment using vacuum chucks 18 is discussed above, other techniques may be used to process panels 12b or layers 12a in a flat or flattened configuration. Another temporary holding technique includes using releasable adhesives to secure the panel 12b or layer 12a to a carrier.

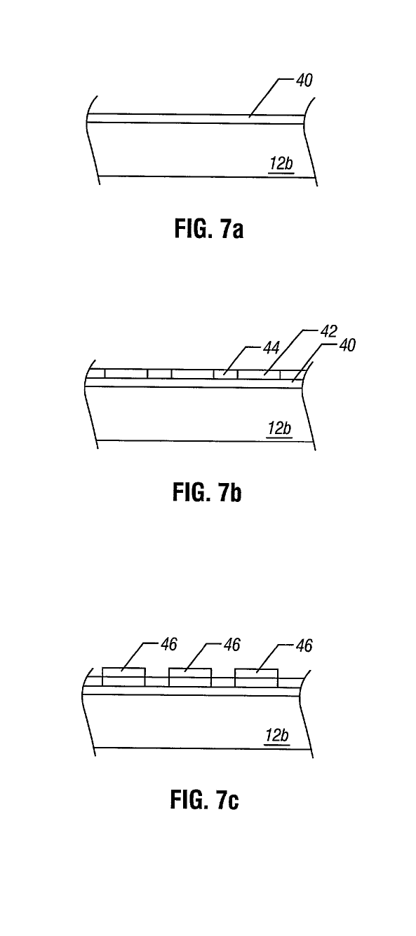

The processing of the display panel 12b, in accordance with one embodiment, may begin by depositing a column electrode 40 on the panel 12b as shown in FIG. 7a. In one embodiment, the column electrode 40 may be formed of a conductive transparent material such as indium tin oxide (ITO). Next, as shown in FIG. 7b, an insulating layer 44 and a light emitting layer 42 may be deposited. In one embodiment, the light emitting layer 42 may be an organic light emitting layer. Next, the row electrodes 46 may be formed atop the resulting composite as shown in FIG. 7c.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
temporarily flattening a sheet;
processing said sheet; and
securing said sheet to a second sheet while continuing to hold said sheet in a flattened configuration.

2. The method of claim 1 wherein temporarily flattening the sheet includes placing the sheet in a vacuum chuck and applying a vacuum to flatten the sheet.

3. The method of claim 1 wherein processing said sheet includes applying row and column electrodes to said sheet.

4. The method of claim 3 wherein processing said sheet includes applying a light emitting material to said sheet.

5. The method of claim 4 wherein applying a light emitting material to said sheet includes applying an organic light emitting material between said row and column electrodes.

6. The method of claim 1 further including processing said second sheet in a flattened configuration.

7. The method of claim 6 including processing said second sheet in a chuck.

8. The method of claim 7 including processing both said first and second sheets in chucks and combining said sheets using said chucks.

9. The method of claim 1 including securing said first and second sheets to an integrator plate.

10. The method of claim 9 including surface mounting said first and second sheets.

11. The method of claim 8 including surface mounting said first and second sheets in said chucks.

12. A method comprising:
receiving a warped sheet;
temporarily flattening said sheet for processing;
processing said flattened, warped sheet; and
securing said flattened, warped sheet to a planar surface.

13. The method of claim 12 including securing said flattened sheet to a second sheet while continuing to hold said flattened sheet in a flattened configuration.

14. The method of claim 12 wherein temporarily flattening the sheet includes placing the sheet in a vacuum chuck and applying a vacuum to flatten the sheet.

15. The method of claim 12 including securing said flattened sheet to a rigid, planar integrating plate.

16. A method comprising:
temporarily flattening a ceramic sheet;
processing a glass panel to define row and column electrodes thereon; and
securing said sheet to said glass panel while continuing to hold said sheet in a flattened configuration.

17. The method of claim 16 including securing said sheet and said panel to an integrating plate.

18. The method of claim 16 wherein temporarily flattening the ceramic sheet by placing the sheet in a vacuum chuck and applying a vacuum to flatten the sheet.

19. The method of claim 16 wherein processing said panel further includes applying an organic light emitting material between said row and column electrodes.

20. The method of claim 16 further including processing both said sheet and said panel in chucks and combining said sheet and said panel using said chucks.
